(19) United States
(12) Patent Application Publication
(10) Pub. No.: US 2010/0288207 A1
(43) Pub. Date: Nov. 18, 2010

(54) Daisy-Chain Pet Leash

(76) Inventors: Patrick Jason Hollenbeck, Colorado Springs, CO (US); Karen Patricia Walldorf, Colorado Springs, CO (US)

Correspondence Address: Patrick Hollenbeck, 601 East Dale Street, Colorado Springs, CO, 80903, US

(21) Appl. No.: 12/464,866

(22) Filed: May 13, 2009

(51) Int. Cl. A01K 27/00

(52) U.S. Cl. 119/797; 119/795

(57) ABSTRACT

A multiple-handle pet leash for pet control and of a non-retractable, flat-material type. The body of the leash consists of a single length of strap material, which is folded over at the middle to capture a spring-clip device. The body of the leash is joined together at increments along the length of the strap material to form a series of apertures or loops. In addition, the handle of the leash shall be of a design which can be unfastened at one end, rendering a single open strap, and refastened using hook-and-loop material to reform the leash handle or to form a larger tie-out loop when fastened through one of the leash body apertures.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to pet leashes, specifically to the design of a non-retractable flat-material leash.

2. Prior Art

Pet leashes have traditionally been made of a single strap of leather, nylon, or similar material. Two fundamental problems are inherent with the basic design. The first problem is that it is difficult to shorten the leash when close control over the pet is needed. Some such situations would be crowded sidewalks, proximity to other animals, and so on. Typically the user would have to grab the body of the leash. In this arrangement the leash could slip through the hand, causing loss of control of the animal or injury to the user. The second problem is that it is difficult to tie the animal to a stationary object. Examples of this would be attaching the leash to a picnic table, or to a tree. Prior patents have been approved which address these issues, but fundamental flaws are apparent in their designs.

U.S. Pat. No. 5,806,467

U.S. Pat. No. 5,806,467 consists of a leash with a large loop at the clip-end, which the user can grab to significantly shorten the length of the leash. There are no options to shorten the leash to different lengths—the leash is either full-length or fully-shortened to the lower loop. The large bottom loop is also cumbersome and awkward because it doesn't flatten into the body of the leash, but instead creates a protrusion that will swing and twist. This is undesirable to the animal and the user.

U.S. Pat. No. 5,806,467 is also intended as a tie-out leash. The handle opens by means of a plastic quick-release buckle. The body of the leash then slips through the nylon buckle to lengthen and shorten it. However, the adjustability of the leash is limited. Additionally, the loop making up the handle is the adjustment loop for the tie-out; it is difficult to return it to a standard loop size for user convenience.

There are multiple nylon stress points that could break, rendering the leash useless. Also, the stitching which attaches the spring clip to the end of the leash could break, allowing the animal to escape.

U.S. Pat. No. 5,456,213

U.S. Pat. No. 5,456,213 is another similar design, which enables the user to tie a pet to an inanimate object and is intended to be able to shorten the leash for more control over the pet. However, this design requires the handle to be used as a “choke collar” to shorten the leash for control. This leaves the leash without an actual handle loop in that situation, and would presumably lead to less control over the animal. The design is also not suitable for tying around one's self, such as around the user's waist, as the leash has nothing but the single square of material to keep the leash from tightening and becoming uncomfortable.

The design in U.S. Pat. No. 5,456,213 also does not allow for multiple shortened lengths of the leash—it is either full-length or it is shortened when using the handle for the “choke collar”, but there are no incremental options for a longer or shorter “shortened” leash.

Finally, as with U.S. Pat. No. 5,806,467, the stitching which attaches the spring clip to the leash could break, allowing the animal to escape.

U.S. Pat. No. 2,861,547

U.S. Pat. No. 2,861,547 shows an adjustable-length design leash. A lot of extra hardware is needed for the manufacture of this leash, as it has 2 clips, multiple metal rings, and multiple attach points for the rings and clips. The attach points could be stress points that would break rendering the leash useless. The options for the shorter lengths of the leash are limited, and the leash cannot be instantly shortened—it is necessary to clip into one of the attached rings to make the leash shorter. This leash also does not appear to allow for any tie-out capability, such as attaching it to a stationary object.

Pat. D. 375,587

Pat. D. 375,587 is an ornamental design similar to U.S. Pat. No. 2,861,547, but it is only used for tying off to a stationary object, and is not intended as a means to shorten or increase control over the animal during conventional walking use.

Pat. D. 350,628

Pat. D. 350,628 is another design patent which allows the user to attach the pet to the user for hands-free control by means of a belt configuration separate from the leash itself. The need for 2 pieces of equipment is undesirable, for if the belt becomes lost the leash is no longer useable for its intended purpose. There are a few apparent stress points in the attachment clips and the adjustment buckles that could break and render the leash assembly unusable.

### SUMMARY

In accordance with one embodiment, a pet leash consists of a series of apertures as the body, an unfasten-able handle at one end, and a spring clip at the opposing end.

### DRAWINGS

The appended drawings along with the following text illustrate and describe the preferred embodiment of this invention.

### BRIEF DESCRIPTION OF THE DRAWINGS

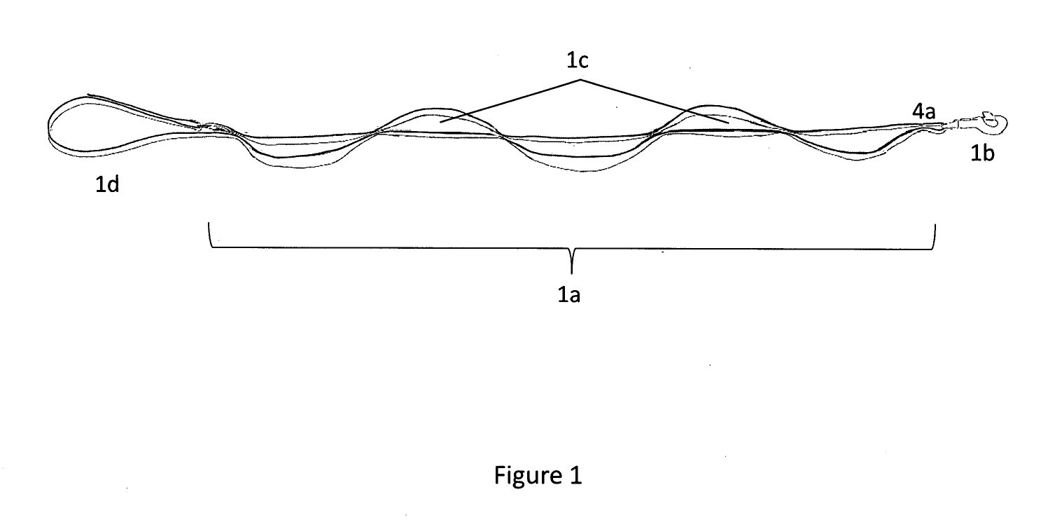

1. FIG. 1 is a perspective overview of the animal leash, with the body shortened and the body apertures exaggerated for convenience of illustration.

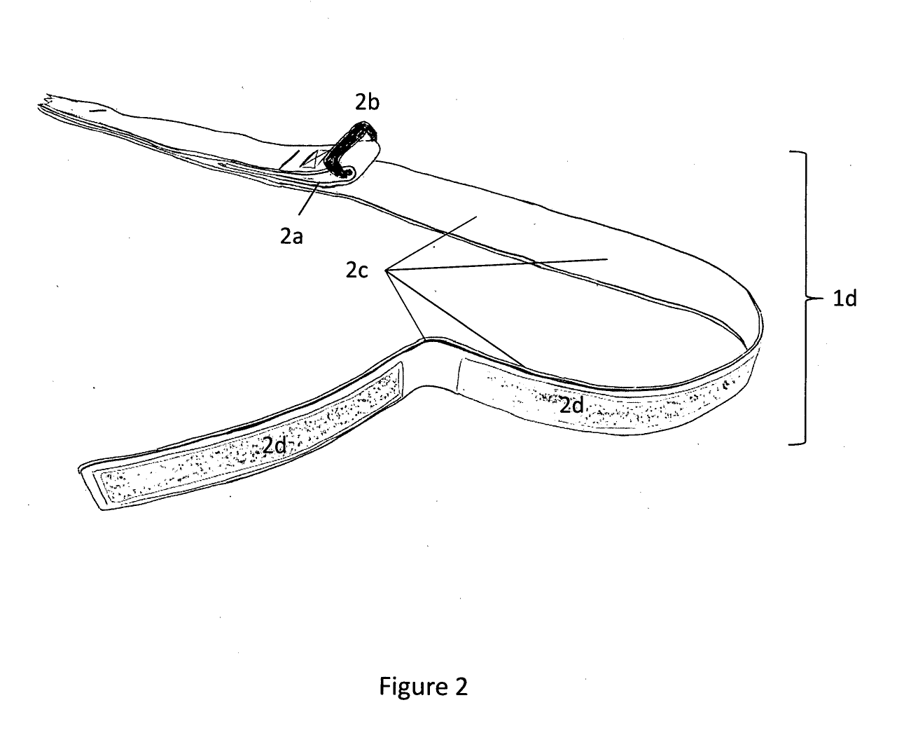

2. FIG. 2 is a perspective detailed view of the unfasten-able leash handle, in which the handle has been detached by pulling apart the hook-and-loop material and slipping it through the rectangular ring, rendering the handle as an open strap configuration.

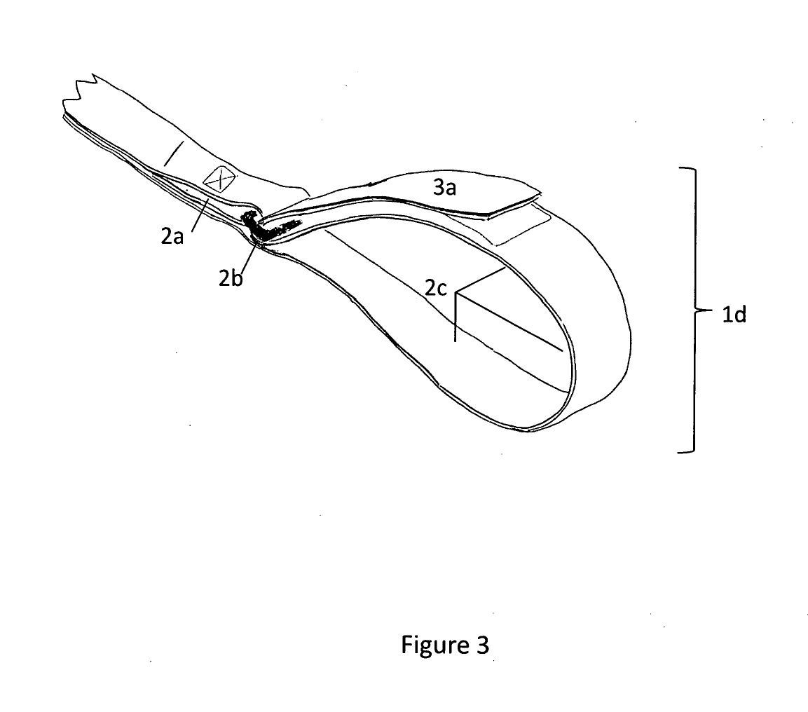

3. FIG. 3 is a perspective detailed view of the leash handle in its closed operational position, wherein the end of the open strap has been passed through the rectangular ring and secured back to itself by means of hook-and-loop material, recreating the leash handle.

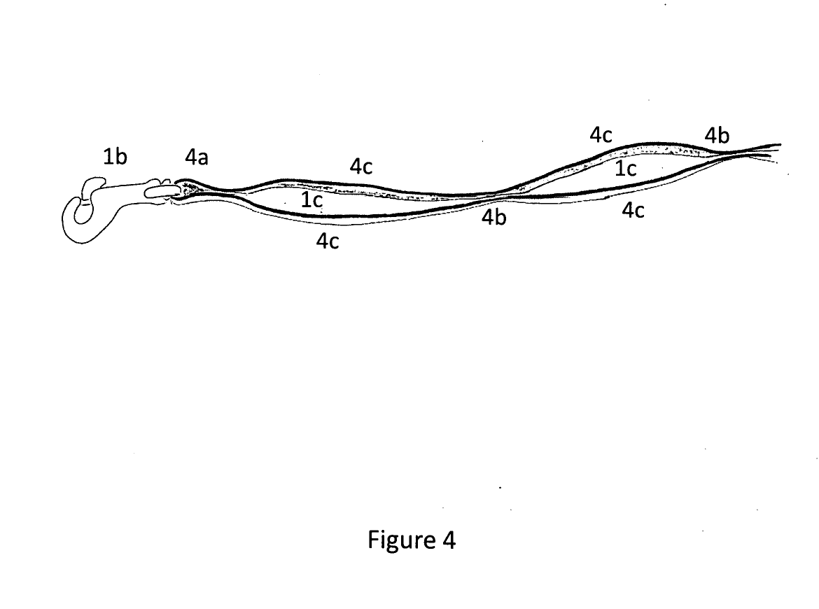

4. FIG. 4 shows a perspective detailed view of the spring-clip end of the leash, and the apertures comprising the leash body.

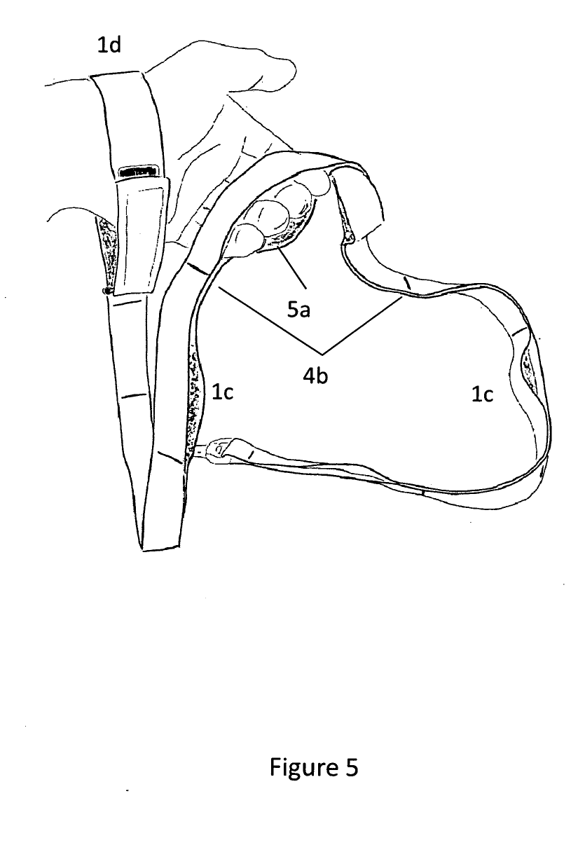

5. FIG. 5 shows a perspective detailed view of the leash in use, with the leash handle encircling the user's wrist and the user's hand inserted into one of the leash body apertures, forming a second handle for close control over the animal.

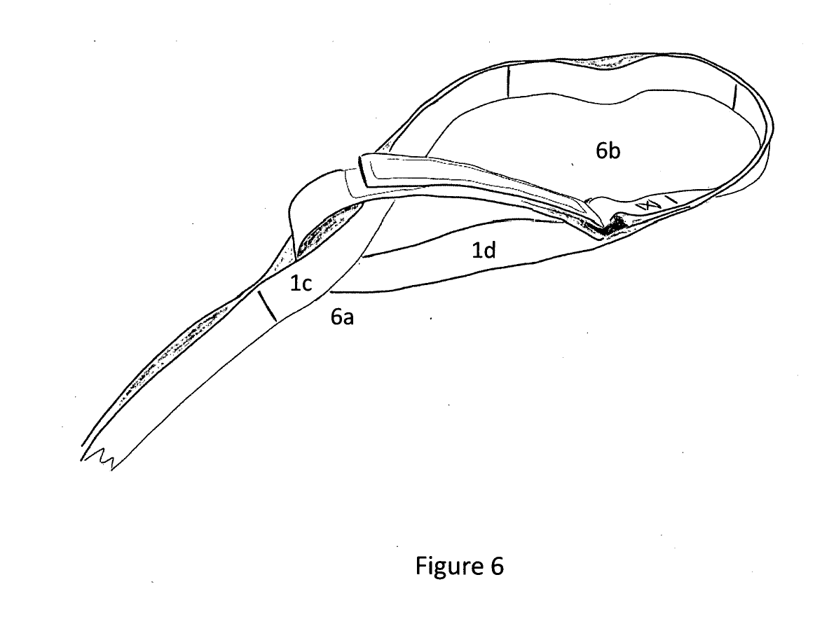

6. FIG. 6 shows a perspective detailed view of the leash handle attached to one of the leash body apertures, creating a larger loop (tie-out loop) which can be wrapped around objects such as a stationary object or the user's body.

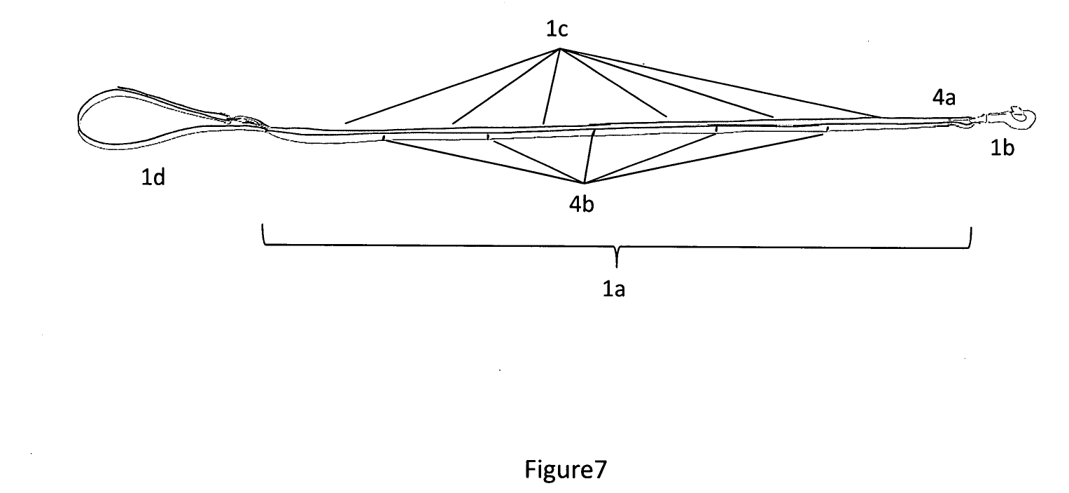

7. FIG. 7 shows an alternative satisfactory embodiment, in which the two straps that form the leash apertures lie flat against one another rather than being slightly opened as in the primary embodiment.

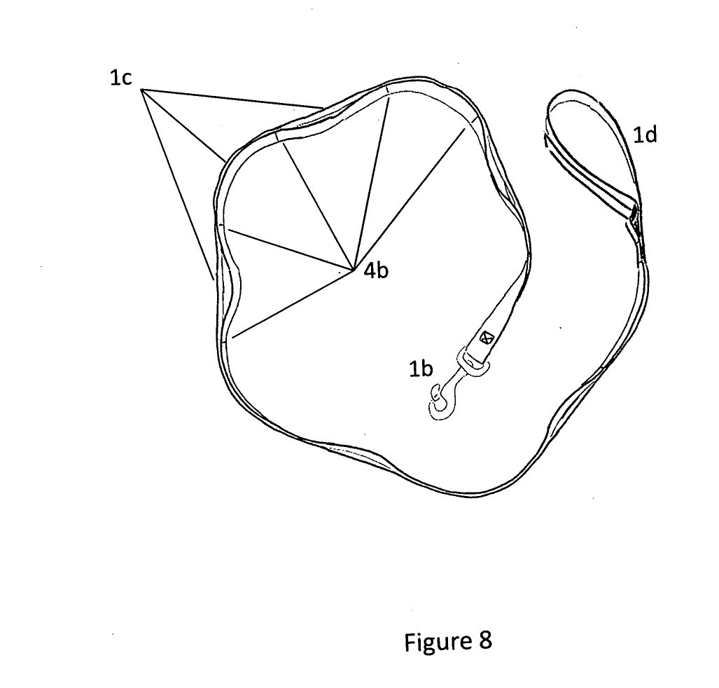

8. FIG. 8 is an alternative perspective overview of the animal leash, shown in its complete form.

### REFERENCE NUMERALS

1a Leash Body

1b Spring-type Clip Device

1c Leash Body Loops (Apertures)

1d Leash Handle

2a Short Leash Body End 1

2b Rectangular Ring

2c Long Leash Body End 2

2d Hook-and-Loop Material

3a Closure Point

4a Doubled Continuous Leash Body Fold

4b Leash Ply Connection Points

4c Ply of Leash Material

5a Additional Loop Handle

6a Connection Point

6b Tie-Out Loop

### DESCRIPTION OF THE PREFERRED EMBODIMENTS

A first embodiment of the present invention will be hereafter described in reference to FIG. 1.

FIG. 1 shows the Leash Body 1a, which includes a doubled-over strap-type portion of material, preferably formed of a long portion of nylon webbing. At the Doubled Continuous Leash Body Fold 4a of the Leash Body 1a is a Spring-type Clip Device 1b for attaching to a ring on a restraint device on the animal, such as a collar or chest harness. The Leash Body 1a is then constructed by joining the leash material together at intervals to create Loops 1c. The remaining end forms a Leash Handle 1d for the user's hand or wrist.

The Leash Handle 1d is shown in detail in FIGS. 2 and 3. FIG. 2 shows the Loop Handle 1d in its “Open” position, while FIG. 3 shows the Loop Handle 1d in its “Closed” position. The Loop Handle 1d is made up of the two terminal ends of the Leash Body 1a. One end terminates by doubling back between the plys as shown at Short Leash Body End 2a. The fold formed by the doubled-back strap captures a plastic, nylon, or metal rectangular ring 2b. The Long Leash Body End 2c should be approximately 20 inches long beyond the Short Leash Body End 2a, and will form the strap for the Leash Handle 1d. Hook-and-Loop Material 2d is attached to the Long Leash Body End 2c to allow it to connect back to itself once inserted through the Rectangular Ring 2b to form a Closure Point 3a.

The Hook-and-Loop Material 2d can be attached to the Leash Handle 1d through a variety of means, including stitching or glue. Stitching is the preferred method as it tends to be stronger than glue. The Hook-and-Loop Material 2d is interchangeable in terms of which is the “hook” material and which is the “loop” material.

The Spring-type Clip Device 1b can be seen in FIGS. 1 and 4. The Doubled Continuous Leash Body Fold 4a captures the Spring-type Clip Device 1b and forms the two Plys of Leash Material 4c which make up the rest of the Leash Body 1a. One advantage to this Doubled Continuous Leash Body Fold 4a and the folded Leash Body design is that the Spring-type Clip Device 1b cannot release from the leash if some of the stitching were to break. It would be constantly attached to the single continuous length of strap material, which is a feature not found in other similar patents.

The Plys of Leash Material 4c are joined together at Leash Ply Connection Points 4b to form Loops 1c, as represented in FIG. 4. The preferred means by which the Plys of Leash Material 4c are joined together is stitching, but other methods are possible as well, such as gluing or riveting. Loops 1c can be made flat, whereby the Plys of Leash Material 4c are of equal length and will situate parallel to one another. FIG. 7 shows an embodiment in which the Loops 1c are flat. Loops 1c can also be made to remain open, by using different length increments of material for each Ply of Leash Material 4c. FIGS. 1 and 8 represent the leash with an embodiment of open Loops 1c.

OPERATION OF THE PREFERRED EMBODIMENT

FIG. 5 shows the user's hand inserted into the Leash Handle 1d, as well as into one of the Loops 1c, using it as an Additional Loop Handle 5a when the user wants to shorten the leash for more control over the animal. Any of the Loops 1c can be used as an Additional Loop Handle 5a, and can be instantly accessed when necessary. Loops 1c can be used as an Additional Loop Handle 5a by either hand, whether the hand already holding the Loop Handle 1d or by the opposite hand for increased control.

An alternative use of the Loops 1c is shown in FIG. 6, where Loops 1c can be used in conjunction with the unfastened Leash Handle 1d to form a Tie-Out Loop 6b, which can be attached to a stationary object such as a tree or bench, or can be attached to the user's body for hands-free control over the pet. The open Leash Handle 1d is run through the appropriate Loop 1c and then refastened to its closed position by running the Long Leash Body End 2c through the Rectangular Ring 2b, and fastened to itself using the Hook-and-loop Material 2d. The resulting Connection Point 6a forms the Tie-Out Loop 6b from the Leash Body 1a.

1. An animal retention device, consisting of:
a. a single length of strap material, doubled over at a spring-type clip device, forming 2 plys of material for the body of said retention device,
b. said material terminating at the other end to be turned back on itself and attached to itself by means of hook-and-loop material to form a loop functioning as the retention device handle, and
c. said plys are adjoined together at spaced intervals by a means,
wherein the body of said retention device forms a series of apertures or loops along its length.

2. An animal retention device according to claim 1 wherein said apertures are large enough to insert a human hand comfortably, but not less than 3 apertures in a retention device body shall be used.

3. An animal retention device according to claim 1 wherein said retention device handle can be attached to said apertures to form a larger loop from said retention device body.
